(19) United States
(12) Patent Application Publication
(10) Pub. No.: US 2021/0374346 A1
(43) Pub. Date: Dec. 2, 2021

(54) BEHAVIORAL INFORMATION GENERATION BASED ON TEXTUAL CONVERSATIONS

(71) Applicant: FUJITSU LIMITED, Kawasaki-shi (JP)

(72) Inventors: Ramya Malur Srinivasan, San Diego, CA (US); Ajay Chander, San Francisco, CA (US)

(73) Assignee: FUJITSU LIMITED, Kawasaki-shi (JP)

(21) Appl. No.: 15/929,967

(22) Filed: May 31, 2020

(51) Int. Cl. G06F 40/289; H04L 12/58; G06F 40/30

(52) U.S. Cl. CPC G06F 40/289; G06F 40/30; H04L 51/16

(57) ABSTRACT

A method includes storing a plurality of textual conversations. Each textual conversation of the plurality of textual conversations corresponds to a plurality of textual messages shared between a plurality of agents and a plurality of customers. The method further includes retrieving a first set of textual conversations of a first time-period from the stored plurality of textual conversations. The first set of textual conversations correspond to a first agent of the plurality of agents. Further, the method includes determining a first set of features of each textual message in the retrieved first set of textual conversations of the first time-period. Furthermore, the method includes determining a first creativity score for the first agent based on the determined first set of features of the first set of textual conversations and generating behavioral communicative information, related to the first agent based on the determined first creativity score.

### FIELD

The embodiments discussed in the present disclosure are related to generation of behavioral information based on agent textual conversations.

### BACKGROUND

Conventional techniques related to customer service feedback are used for assessment of performance of customer service agents (such as humans). Certain conventional techniques such as sentiment analysis, reviews and ratings provided by a customer, social engagement with the customer, survey responses, and so forth are used for the assessment i.e., evaluation of customer services or assistance provided by the agents to the customers. Such techniques are subjective in nature as the feedback or ratings from each customer may vary based on various factors, such as customer experience, cultural differences, emotional state of the customer and the like. In light of the abovementioned problems, the conventional techniques may not provide fair and detailed assessment of performance of the customer service agents or customers. Therefore, an advanced system may be required which may provide unbiased and fine-grained performance evaluation of the customer service agents that may further drive the customer service agents to perform better.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may be provided. The method may comprise storing a plurality of textual conversations. Each textual conversation of the plurality of textual conversations corresponds to a plurality of textual messages shared between a plurality of agents and a plurality of customers. The method may further comprise retrieving a first set of textual conversations of a first time-period from the stored plurality of textual conversations. The first set of textual conversations correspond to a first agent of the plurality of agents. The method may further comprise determining a first set of features of each textual message in the retrieved first set of textual conversations of the first time-period. Furthermore, the method may comprise determining a first creativity score for the first agent based on the determined first set of features of the first set of textual conversations. Moreover, the method may comprise generating behavioral communicative information, related to the first agent, based on the determined first creativity score.

According to an aspect of another embodiment, an electronic device may be provided. The electronic device may include a memory that may be configured to store a plurality of textual conversations. Each textual conversation of the plurality of textual conversations corresponds to a plurality of textual messages shared between a plurality of agents and a plurality of customers. The electronic device may further include a processor coupled to the memory. The processor may be configured to retrieve a first set of textual conversations of a first time-period from the stored plurality of textual conversations. The first set of textual conversations correspond to a first agent of the plurality of agents. The processor may be further configured to determine a first set of features of each textual message in the retrieved first set of textual conversations of the first time-period. Moreover, the processor may be configured to determine a first creativity score for the first agent based on the determined first set of features of the first set of textual conversations. Furthermore, the processor may be configured to generate behavioral communicative information, related to the first agent, based on the determined first creativity score.

The objects and advantages of the embodiments will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a diagram representing an example environment related to generation of behavioral information based on textual conversations;

FIG. 2 is a block diagram that illustrates an exemplary electronic device for generation of behavioral information based on textual conversations;

FIG. 3 illustrates a flowchart of an example method for generation of behavioral information related to an agent based on textual conversations;

FIG. 4A and FIG. 4B illustrate a flowchart of an example method for determination of a set of creativity score for a set of textual conversations, and illustrates an exemplary graph that depicts a set of edge weights between the set of textual conversations, respectively;

FIG. 5A and FIG. 5B illustrate a flowchart of an example method for determination of a first creativity score for the first agent and a second creativity score for a second agent for the generation of the behavioral information, and illustrates an exemplary graph that depicts the set of edge weights between the plurality of textual conversations of plurality of agents, respectively;

all according to at least one embodiment described in the present disclosure.

### DESCRIPTION OF EMBODIMENTS

Some embodiments described in the present disclosure relate to methods and electronic device for generation of behavioral information associated with agents (for example customer service agents). The method in the present disclosure achieves generation of the behavioral information based on assessment of a plurality of textual conversations (for example chats messages exchanged between customer service agents and customers on online chat portals), related to an agent (for example a customer service agent). The method may include storing the plurality of textual conversations, where each textual conversation of the plurality of textual conversations may correspond to a plurality of textual messages shared between a plurality of agents (for example multiple customer service agents) and plurality of customers). The method may further include retrieving a first set of textual conversations of a first time-period (for example of a week) from the stored plurality of textual conversations. The first set of textual conversations may correspond to a first agent (for example textual conversations of the first customer service agent with one or more customers). Furthermore, the method may include determining a first set of features (for example a numeric score of each word based on semantic and syntactic analysis performed using natural language processing) of each textual message in the retrieved first set of textual conversations of the first time-period. Moreover, the method may include determining a first creativity score (for example a score which may indicate a novelty of first set of textual conversations) for the first agent based on the determined first set of features of the first set of textual conversations. Furthermore, the method may include generating behavioral information related to the first agent (for example information related to conduct or behavior of the first customer service agent while communicating with the customers), based on the determined first creativity score.

According to one or more embodiments of the present disclosure, the method may include computation of a first set of similarities (for example one or more words that are common in the first set of textual conversations) between the determined first set of features for the first set of textual conversations. The first set of similarities may be computed based on, for example, a cosine similarity function. Furthermore, a first set of edge weights (for example numeric values) may be determined between the first set of textual conversations of the first agent based on the determined first set of similarities. Moreover, the method may further include determining a first set of creativity scores (for example, creativity score for each conversation of the first customer service agent) for the first set of textual conversations for the first time-period, based on the determined first set of edge weights. Thus, the first agent (for example the first customer service agent) may be provided a feedback (for example in form of the creativity score and the behavioral information) that may be indicative of the performance of the first agent (i.e. the first customer service agent). The performance of the first customer service agent may be based on parameters such as, but not limited to, politeness of the first customer service agent, understanding of customer query, an influence of the first customer service agent on other agents, and so forth.

In one or more embodiments, the disclosed method may include retrieval of a second set of textual conversations for a second agent (for example multiple conversations of a second customer service agent with customers) of a second time-period (for example of one month) from the stored plurality of textual conversations. The first set of edge weights (for example numeric values) may be determined between the first set of textual conversations (conversations of the first customer service agent) of the first agent and the second set of textual conversations (conversations of the second customer service agent) of the second agent. The determined first set of edge weights may indicate the influence of one agent on other agents.

Furthermore, the disclosed method may include determination of a second set of creativity scores (for example, creativity score for each conversation of the second customer service agent) for the second set of textual conversations for the second time-period, based on the determined first set of edge weights. Moreover, the method may further include determination of a set of similarities between the first set of creativity scores determined for the first agent for the first time-period and the second set of creativity scores determined for the second agent for the second time-period. Further, the method may include determination of the first creativity score for the first agent and a second creativity score for the second agent (for example a score indicating factors, such as novelty of the second set of textual conversations and influence) based on the determined set of similarities. The determined creativity scores may be provided to the agents (for example customer service agents) as behavioral feedback (i.e. whether a particular agent was polite or rude while communicating with customers). Thus, the agents (such as the customer service agents) may be provided the respective behavioral feedbacks based on the comparison of the textual conversations and the determined creativity scores for different customer service agents or customers. The provided feedback may be utilized for evaluation of the performance of each agent (i.e. customer service agent). Therefore, the disclosed method may provide unbiased, detailed, and fine-grained performance evaluation of the customer service agents or customers for the analyzed textual conversations, where the evaluation may further drive the customer service agents or customers to perform and/or communicate in improved manner in future. The proposed method may also provide objective evaluation of the performance of the agent, such as the customer service agent, based on the determination of various factors, such as the creativity scores or weights indicating an influence of one agent on other agents.

Embodiments of the present disclosure are explained with reference to the accompanying drawings.

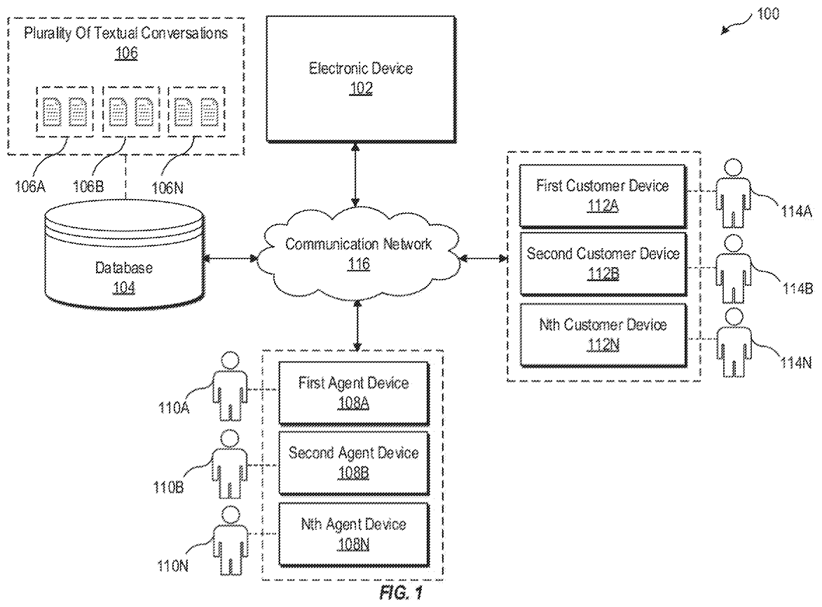

FIG. 1 is a diagram representing an example environment related to generation of behavioral information based on textual conversations, arranged in accordance with at least one embodiment described in the present disclosure. With reference to FIG. 1, there is shown an environment 100. The environment 100 may include an electronic device 102. The environment 100 may further include a database 104. The database may further include a plurality of textual conversations 106. The plurality of textual conversations 106 may include a first set of textual conversations 106A, a second set of textual conversations 106B, and an Nth set of textual conversations 106N. Moreover, the environment 100 may include a plurality of agent devices which may further include a first agent device 108A, a second agent device 108B, a Nth agent device 108N. The environment 100 may further include a plurality of customer devices which may further include a first customer device 112A, a second customer device 112B, and Nth customer device 112N. The environment 100 may further include a communication network 116. Furthermore, the environment 100 may include a first agent 110A, a second agent 110B, and Nth agent 110N who may be associated with the first agent device 108A, the second agent device 108B, the Nth agent device 108N, respectively, as shown in FIG. 1. Furthermore, the environment 100 may include a plurality of customers that may further include a first customer 114A, a second customer 114B, and Nth customer 114N who may be associated with the first customer device 112A, the second customer device 112B, and the Nth customer device 112N, respectively, as shown in FIG. 1. For example, the first agent 110A, the second agent 110B, and the Nth agent 110N may be, but not limited to, customer service agents who may communicate with the first customer 114A, the second customer 114B, and the Nth customer 114N through the plurality of textual conversations 106.

As shown in FIG. 1, the electronic device 102, the database 104, the first agent device 108A, the second agent device 108B, the Nth agent device 108N, the first customer device 112A, the second customer device 112B, and the Nth customer device 112N may be communicatively coupled to the communication network 116. In an exemplary embodiment, the functionalities of the electronic device 102 may be integrated within one of the first agent device 108A, the second agent device 108B, the Nth agent device 108N, the first customer device 112A, the second customer device 112B, or the Nth customer device 112N. It may be noted that number of the first agent device 108A, the second agent device 108B, and the Nth agent device 108N; the number of the first customer device 112A, the second customer device 112B, and the Nth customer device 112N, shown in FIG. 1, are presented merely as an example. The environment 100 may include any number of the agent devices and the customer devices, without deviation from the scope of the disclosure.

The electronic device 102 may comprise suitable logic, circuitry, interfaces, and/or code that may be configured to perform one or more operations for determination of a first creativity score associated with a first agent (such as the first agent 110A) based on analysis of the plurality of textual conversations 106. The electronic device 102 may further be configured to generate behavioral information associated with the first agent 110A (for example, information related to conduct or behavior of the first agent 110A while communicating with customers, such as the first customer 114A and the second customer 114B) based on the determined first creativity score. Examples of the electronic device 102 may include, but are not limited to, a controlling device, a data analyzer system, a messaging gateway, a messaging server, a chat or email processing device, a text processing device, computing device, a smartphone, a cellular phone, a mobile phone, a mainframe machine, a server, a computer workstation, a laptop, or a desktop computer.

The database 104 may include suitable logic, circuitry, interfaces and/or code that may be configured to store the plurality of textual conversations 106, such as the first set of textual conversations 106A, the second set of textual conversations 106B, and the Nth set of textual conversations 106N. The database 104 may be a relational or a non-relational database that include the plurality of textual conversations 106. Also, in some cases, the database 104 may be stored on a server, such as a cloud server or may be cached and stored on the electronic device 102. The server of the database 104 may be configured to receive a request to provide the plurality of textual conversations 106 from the electronic device 102, via the communication network 116. In response, the server of the database 104 may be configured to retrieve and provide the plurality of textual conversations 106 to the electronic device 102 based on the received request, via the communication network 116. In some embodiments, the database 104 may be configured to store the behavioral information generated by the electronic device 102. Additionally or alternatively, the database 104 may be implemented using hardware including a processor, a microprocessor (e.g., to perform or control performance of one or more operations), a field-programmable gate array (FPGA), or an application-specific integrated circuit (ASIC). In some other instances, the database 104 may be implemented using a combination of hardware and software.

Each of the plurality of textual conversations 106 may correspond to a plurality of textual messages shared between the plurality of agents (i.e. that may include the first agent 110A, for example a first customer service agent) and a plurality of customers (i.e. that may include the first customer 114A and the second customer 114B). For example, the first set of textual conversations 106A in the plurality of textual conversations 106 may include textual record of the messages shared between the first agent 110A with the plurality of customers over a first time-period period. In accordance with an embodiment, the plurality of textual messages of the plurality of textual conversations 106 may include chat messages, short messaging service (SMS) messages, or electronic mails (e-mail). In an example, the first time-period may be defined in, but is not limited to, hours, days, weeks, months, years, and so forth. For example, the first set of textual conversations 106A may include the textual messages shared between the first agent 110A and the plurality of customers over the first time-period (say in last one week). In an exemplary embodiment, the first agent 110A may respond to queries associated with or raised by the plurality of customers (such as the first customer 114A and the second customer 114B). In an exemplary scenario, the first agent 110A may receive a query from the first customer 114A, where the query may include, for example, “Hello, I want to open a new bank account”. The first agent 110A may respond to the first customer 114A with a textual response, for example, “Hello Sir, here is a link to the form you need to click for opening the bank account”. The received query and the provided response may correspond to textual messages included in one of textual conversation of the first set of textual conversations 106A. Thus, the first set of textual conversations 106A associated with the first agent 110A may include the textual messages shared between the first agent 110A and the first customer 114A, and other textual messages shared between the first agent 110A and other customers (such as the second customer 114B) of the plurality of customers.

The second set of textual conversations 106B may correspond to a plurality of textual messages shared between the second agent 110B (for example a second customer service agent) and the plurality of customers (i.e. the first customer 114A and the second customer 114B). The second set of textual conversations 106B may include textual record of the messages shared between the second agent 110B and the plurality of customers over a second time-period period (for example in last one month). In accordance with an embodiment, a length or duration of the first time-period and a length of the second time-period may be different from each other. For example, the length of the first time-period is a week, and the length or duration of the second time-period may be one month. For example, the second set of textual conversations 106B may include the textual messages shared between the second agent 110B and N number customers, over the second time-period. In an exemplary embodiment, the second agent 110B may respond to queries received from one or more of the plurality of customers. In an exemplary scenario, the second agent 110B may receive a query from a second customer 114B, such as “I would like to return my order”. The second agent 110B may respond to the second customer 114 with text response, for example, “Hello, May I know the reason for return of your order?”. The received query and the provided response may correspond to textual message included in one of textual conversation of the second set of textual conversations 106B. Thus, the second set of textual conversations 106B associated with the second agent 110B may include the textual messages shared between the second agent 110B and the plurality of customers in the second time-period.

Each of the first agent device 108A, the second agent device 108B, and the Nth agent device 108N may include suitable logic, circuitry, and interfaces that may be configured to provide an interface (such as the graphical user interface (GUI)) to the plurality of agents (such as the first agent 110A, the second agent 110B) to communicate with the plurality of customers, and share textual messages (as the plurality of textual conversations 106) with the plurality of customers, such as the first customer 114A. Examples of the first agent device 108A, the second agent device 108B, and the Nth agent device 108N may include, but are not limited to, a chat messenger device, an email device, a smartphone, a cellular phone, a mobile phone, a laptop, a mainframe machine, a server, a computer work-station, and/or a consumer electronic (CE) device. In some embodiments, at least one of the first agent device 108A, the second agent device 108B, and the Nth agent device 108N may include a software application (for example a chat messenger) to communicate with the plurality of customers through textual messages.

Each of the first customer device 112A, the second customer device 112B, and the Nth customer device 112N may include suitable logic, circuitry, and interfaces that may be configured to provide an interface (such as the graphical user interface (GUI)) to the plurality of customers (such as the first customer 114A and the second customer 114B to communicate with the plurality of agents, and share the textual messages (i.e. plurality of textual conversations 106) with the plurality of agents, such as the first agent 110A. Examples of the first customer device 112A, the second customer device 112B and the Nth customer device 112N may include, but are not limited to, a chat messenger device, an email device, a smartphone, a cellular phone, a mobile phone, a laptop, a mainframe machine, a server, a computer work-station, and/or a consumer electronic (CE) device. In some embodiments, at least one of the first customer device 112A, the second customer device 112B, and the Nth customer device 112N may include a software application (for example a chat messenger) to communicate with the plurality of agents through textual messages.

In an embodiment, the plurality of agents (such as the first agent 110A, the second agent 110B, and the Nth agent 110N) may correspond to a customer service agent. The plurality of agents may be associated with (or may be an employee) of any organization such as, but not limited to, a customer service agency, a bank, a retail store, a manufacturing company, an educational agency, a service provider, and so forth. The plurality of agents may respond to the queries raised by the plurality of customers (such the first customer 114A) who may be the customers of the organization. For example, the first agent 110A associated with the bank may respond to queries of the first customer 114A of the bank.

In an exemplary embodiment, the first agent 110A and the second agent 110B of the plurality of agents may be employed within a same organization. In an exemplary embodiment, the database 104 may be maintained by the organization associated with the first agent 110A and the second agent 110B to store the plurality of textual conversations 106 of the first agent 110A and the second agent 110B with the plurality of customers, such as the first customer 114A and the second customer 114B. In an exemplary embodiment, the plurality of customers (such as the first customer 114A and the second customer 114B) may be customers of an organization, such as the organization in which the first agent 110A, the second agent 110B or the Nth agent 110N may be employed.

It may be noted that the plurality of agents considered as customer service agents, and the plurality of customers considered as the customers to the customer service agents, in FIG. 1, is merely an example. In an embodiment, the plurality of agents and the plurality of customers may be any human being who may be interacting with each other through textual messages, like chat messages, SMS, or emails, without any deviation from the scope of the disclosure.

The communication network 116 may include a communication medium through which the electronic device 102, the database 104, the first agent device 108A, the second agent device 108B, the Nth agent device 108N, the first customer device 112A, the second customer device 112B, and the Nth customer device 112N may communicate with each other. The communication network 116 may be one of a wired connection or a wireless connection Examples of the communication network 116 may include, but are not limited to, the Internet, a cloud network, a Wireless Fidelity (Wi-Fi) network, a Personal Area Network (PAN), a Local Area Network (LAN), or a Metropolitan Area Network (MAN). Various devices in the environment 100 may be configured to connect to the communication network 116 in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), Zig Bee, EDGE, IEEE 802.11, light fidelity (Li-Fi), 802.16, IEEE 802.11s, IEEE 802.11g, multi-hop communication, wireless access point (AP), device to device communication, cellular communication protocols, and Bluetooth (BT) communication protocols.

In operation, the electronic device 102 may receive a request to analyze the stored plurality of textual conversations 106 to determine the behavioral information of various people (such as the first agent 110A, the second agent 110B, the first customer 114A or the second customer 114B) involved in the plurality of textual conversations 106. In an embodiment, the request may be received from a user (for example an executive, a manager, a supervisor, or a department) associated with the electronic device 102. In some embodiments, the request may be received from a person (for example the first agent 110A or the first customer 114A) who may be involved in one or more of the plurality of textual conversations 106. The request may be received from a user interface (UI) associated with the electronic device 102.

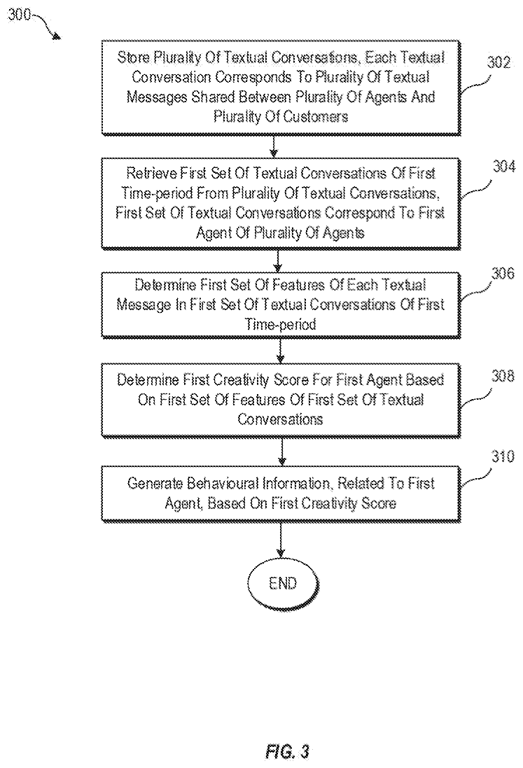

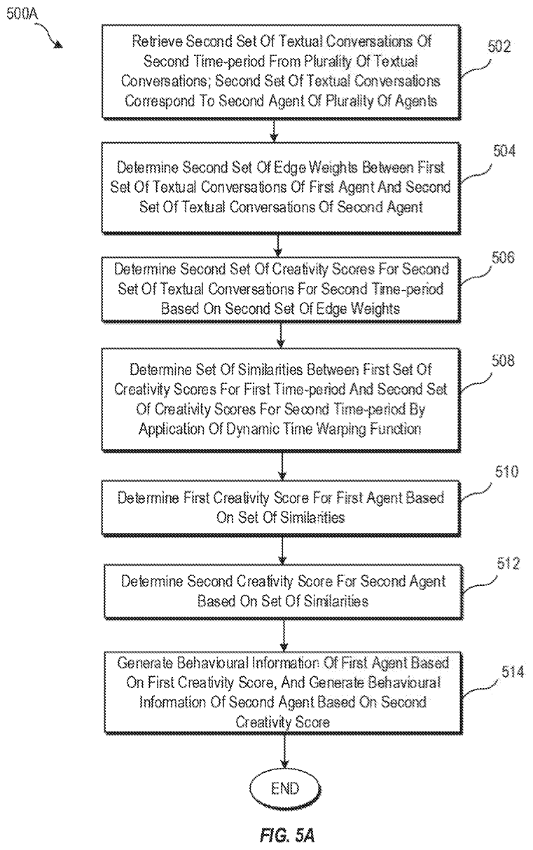

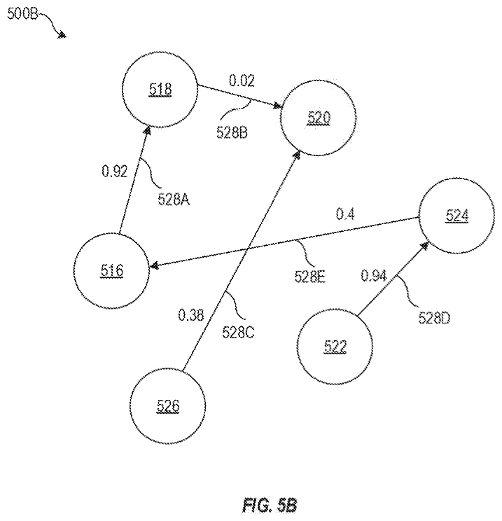

In response of the received request, the electronic device 102 may be further configured to retrieve the first set of textual conversations 106A (i.e. associated with the first agent 110A) of the first time-period from the stored plurality of textual conversations 106. The electronic device 102 may further be configured to determine a first set of features of each textual message in the retrieved first set of textual conversations 106A of the first time-period. Details of the determination of the first set of features by the electronic device 102 are provided, for example, in FIG. 3. The electronic device 102 may be further configured to determine a first creativity score for the first agent 110A based on the determined first set of features of the first set of textual conversations 106A. Details of the determination of the creativity score for the first agent 110A are provided, for example, in FIGS. 3, 4A, 4B, 5A, and 5B. The electronic device 102 may further generate behavioral information, related to the first agent 110A, based on the determined first creativity score. Details of the generation of behavioral information, related to the first agent 110A by the electronic device 102 are provided, for example, in FIGS. 3 and 5A.

In accordance with an embodiment, the electronic device 102 may be further configured to retrieve the second set of textual conversations 106B (i.e. associated with the second agent 110B, for example, another customer service agent) of the second time-period from the database 104. The electronic device 102 may further determine a second creativity score for the second agent 110B. Details of the determination of the second creativity score for the second agent 110B by the electronic device 102 are provided, for example, in FIGS. 5A and 5B. The electronic device 102 may further be configured to generate the behavioral information, related to the second agent 110B, as described, for example, in FIG. 5A.

Modifications, additions, or omissions may be made to FIG. 1 without departing from the scope of the present disclosure. For example, the environment 100 may include more or fewer elements than those illustrated and described in the present disclosure. For instance, in some embodiments, the environment 100 may include the electronic device 102 but not the first agent 110A or the second agent device 108B. In addition, in some embodiments, the functionality of the first agent device 108A or the second agent device 108B may be incorporated into the electronic device 102, without a deviation from the scope of the disclosure. For instance, in some embodiments, the environment 100 may include the electronic device 102 but not the database 104. In such scenario, the functionality of the database 104 may be incorporated into the electronic device 102, without a deviation from the scope of the disclosure.

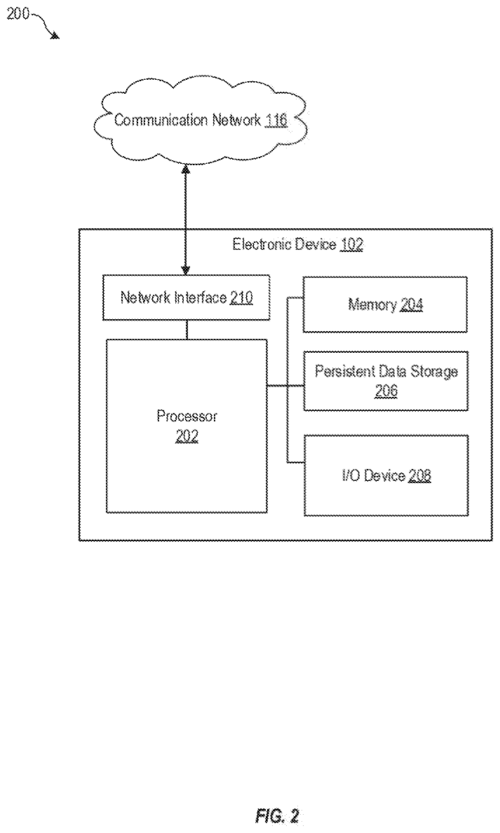

FIG. 2 is a block diagram that illustrates an exemplary electronic device for generation of behavioral information based on textual conversations, arranged in accordance with at least one embodiment described in the present disclosure. FIG. 2 is explained in conjunction with elements from FIG. 1. With reference to FIG. 2, there is shown a block diagram 200 of the electronic device 102. The electronic device 102 may include a processor 202, a memory 204, a persistent data storage 206, an input/output (I/O) device 208, and a network interface 210.

The processor 202 may comprise suitable logic, circuitry, and/or interfaces that may be configured to execute program instructions associated with different operations to be executed by the electronic device 102. For example, some of the operations may include, but are not limited to, retrieval of the first set of textual conversations 106A of the first time-period from the stored plurality of textual conversations 106, determination of the first set of features of each textual message in the retrieved first set of textual conversations 106A of the first time-period, determination of the first creativity score for the first agent 110A based on the determined first set of features of the first set of textual conversations 106A, and generation of the behavioral information, related to the first agent 110A, based on the determined first creativity score. The processor 202 may include any suitable special-purpose or general-purpose computer, computing entity, or processing device including various computer hardware or software modules and may be configured to execute instructions stored on any applicable computer-readable storage media. For example, the processor 202 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 202 may include any number of processors configured to, individually or collectively, perform or direct performance of any number of operations of the electronic device 102, as described in the present disclosure. Additionally, one or more of the processors may be present on one or more different electronic devices, such as different servers.

In some embodiments, the processor 202 may be configured to interpret and/or execute program instructions and/or process data stored in the memory 204 and/or the persistent data storage 206. In some embodiments, the processor 202 may fetch program instructions from the persistent data storage 206 and load the program instructions in the memory 204. After the program instructions are loaded into the memory 204, the processor 202 may execute the program instructions. Some of the examples of the processor 202 may be a graphics processing unit (GPU), a central processing unit (CPU), a Reduced Instruction Set Computer (RISC) processor, an application-specific integrated circuit (ASIC) processor, a complex instruction set computer (CISC) processor, a co-processor, and/or a combination thereof.

The memory 204 may comprise suitable logic, circuitry, and/or interfaces that may be configured to store program instructions executable by the processor 202. In certain embodiments, the memory 204 may be configured to store operating systems and associated application-specific information. The memory 204 may include computer-readable storage media for carrying or having computer-executable instructions or data structures stored thereon. Such computer-readable storage media may include any available media that may be accessed by a general-purpose or special-purpose computer, such as the processor 202. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the electronic device 102.

The persistent data storage 206 may comprise suitable logic, circuitry, and/or interfaces that may be configured to store program instructions executable by the processor 202, operating systems, and/or application-specific information, such as logs and application-specific databases. The persistent data storage 206 may include computer-readable storage media for carrying or having computer-executable instructions or data structures stored thereon. Such computer-readable storage media may include any available media that may be accessed by a general-purpose or special-purpose computer, such as the processor 202.

By way of example, and not limitation, such computer-readable storage media may include tangible or non-transitory computer-readable storage media including Compact Disc Read-Only Memory (CD-ROM) or other optical disk storage, magnetic disk storage or other magnetic storage devices (e.g., Hard-Disk Drive (HDD)), flash memory devices (e.g., Solid State Drive (SSD), Secure Digital (SD) card, other solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 202 to perform a certain operation or group of operations associated with the electronic device 102.

In some embodiments, either of the memory 204, the persistent data storage 206, or combination may store the plurality of textual conversations 106. The processor 202 may fetch the plurality of textual conversations 106, to perform different operations of the disclosed electronic device 102, from the memory 204, the persistent data storage 206 or combination. In some embodiments, either of the memory 204, the persistent data storage 206, or combination may store the determined creativity scores for the plurality of agents or the plurality of customers, and the generated behavioral information related to the plurality of agents (such as the first agent 110A) or the plurality of customers (such as the first customer 114A).

The I/O device 208 may include suitable logic, circuitry, interfaces, and/or code that may be configured to receive a user input. For example, the electronic device 102 may receive the user input to initiate generation of the behavioral information of the agents (such as the customer service agents) in an organization, based on the stored plurality of textual conversations 106. The user input may be received from a user (for example an executive or a supervisor) who may be directly interacting with the electronic device 102. In some embodiments, where the electronic device 102 may be integrated with the first agent device 108A or the second agent device 108B, the electronic device 102 may be configured to receive user input from the first agent 110A or the second agent 110B to respond to the queries (textual message) associated with the plurality of customers (such as the first customer 114A). The I/O device 208 may further be configured to display the queries received from the plurality of customers or the responses provided by the plurality of agents (like customer service agents). For example, the I/O device 208 may receive a first query from the first customer 114A. The I/O device 208 may display the received first query to the first agent 110A. The I/O device 208 may further receive the user input from the first agent 110A in response to the first query received from the first customer 114A.

The I/O device 208 may include various input and output devices, which may be configured to communicate with the processor 202 and other components, such as the network interface 210. Examples of the input devices may include, but are not limited to, a touch screen, a keyboard, a mouse, a joystick, and/or a microphone. Examples of the output devices may include, but are not limited to, a display and a speaker.

The network interface 210 may comprise suitable logic, circuitry, interfaces, and/or code that may be configured to establish a communication between the electronic device 102, a server including the database 104, the first agent device 108A, the second agent device 108B, the Nth agent device 108N, the first customer device 112A, the second customer device 112B, and the Nth customer device 112N, via the communication network 116.

The network interface 210 may be implemented by use of various known technologies to support wired or wireless communication of the electronic device 102 via the communication network 116. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The network interface 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), light fidelity (Li-Fi), or Wi-MAX.

Modifications, additions, or omissions may be made to the example electronic device 102 without departing from the scope of the present disclosure. For example, in some embodiments, the example electronic device 102 may include any number of other components that may not be explicitly illustrated or described for the sake of brevity.

FIG. 3 illustrates a flowchart of an example method for generation of behavioral information related to an agent based on textual conversations, according to at least one embodiment described in the present disclosure. FIG. 3 is explained in conjunction with elements from FIG. 1 and FIG. 2. With reference to FIG. 3, there is shown a flowchart 300. The method illustrated in the flowchart 300 may start at 302 and may be performed by any suitable system, apparatus, or device, such as by the example electronic device 102 of FIG. 1 or the processor 202 of FIG. 2. For example, one or more of the electronic device 102, the first agent device 108A, the second agent device 108B, the first customer device 112A, or the second customer device 112B may perform one or more of the operations associated with the method. Although illustrated with discrete blocks, the steps and operations associated with one or more of the blocks of the method may be divided into additional blocks, combined into fewer blocks, or eliminated, depending on the particular implementation.

At block 302, the plurality of textual conversations 106 may be stored in the memory 204 or in the persistent data storage 206 of the electronic device 102. Each of the textual conversation of the plurality of textual conversations 106 may correspond to the plurality of textual messages shared between the plurality of agents and the plurality of customers. The plurality of agents may include the first agent 110A (for example the first customer service agent), the second agent 110B (for example the second customer service agent) and the Nth agent 110N. The plurality of customers may include the first customer 114A, the second customer 114B, and the Nth customer 114N.

In accordance with an embodiment, the plurality of textual messages of the plurality of textual conversations 106 may include, but are not limited to, chat messages, short messaging service (SMS) messages, or electronic mails (e-mail). For example, the one or more of the plurality of customers may communicate with the first agent 110A or the second agent 110B, via an online chat portal. In another example, the first agent 110A or the second agent 110B may receive queries or messages from one or more of the plurality of customers via the e-mail, and further the first agent 110A or the second agent 110B may respond to the received queries or messages, via the e-mail. In some embodiments, the plurality of textual conversations 106 may be stored in the database 104. In accordance with an embodiment, the plurality of textual conversations 106 may be associated with, but not limited to, a set of agents (such messages of the first agent 110A, the second agent 110B, the first customer 114A, or the second customer 114B), a particular geo-location (for examples, messages related to a city, state, country, or continent), an organization (for example messages of a customer service company or an organization) or a service (for example messages of an instant messaging service).

Examples of the plurality of textual conversations 106 are presented in Table 1, as follows:

TABLE 1
Examples of plurality of textual conversations

| First | Second | | |
|---|---|---|---|
| Party | Party | Exemplary Message | Time-Period |
| First | First | First Customer: I need help | Date: 2 Jan. 2019 |
| Agent | Customer | with passport application | Time: 08/50 |
| | | process. | |
| | | First Agent: Sure, could you | |
| | | please give me some details | |
| | | such as dob, country, etc.? | |
| First | Second | Second Customer: I want to | Date: 5 Jan. 2019 |
| Agent | Customer | apply for passport. | Time: 14/30 |
| | | First Agent: Can you provide | |
| | | details of your residence? | |
| Second | Third | Third Customer: I need help | Date: 2 Feb. 2019 |
| Agent | Customer | opening a bank account. | Time: 10/14 |
| | | Second Agent: Sure, please | |
| | | provide some details. | |
| Second | First | First Customer: I need help | Date: 19 Mar. 2019 |
| Agent | Customer | opening a bank account. | Time: 16/42 |
| | | Second Agent: I am busy, | |
| | | don't disturb. | |
| First | Nth | Nth Customer: I would like | Date: 12 May 2019 |
| Agent | Customer | to return my order. | Time: 17/00 |
| | | First Agent: It is against our | |
| | | policy. | |

At block 304, the first set of textual conversations 106A of the first time-period may be retrieved from the stored plurality of textual conversations 106. In an embodiment, the processor 202 may be configured to retrieve the first set of textual conversations 106A of the first time-period from the plurality of textual conversations 106 stored in the memory 204, the persistent data storage 206, or the database 104. The first set of textual conversations 106A may correspond to or associated with the first agent 110A (for example the first customer service agent) of the plurality of agents. The first set of textual conversations 106A may include the plurality of textual messages shared between the first agent 110A and one or more of the plurality of customers. For example, the first set of textual conversations 106A may include a plurality of text queries received from one or more of the plurality of customers, and further include text responses provided by the first agent 110A for the received queries. In some embodiment, the queries can be initiated by the first agent 110A, through the first agent device 108A, and responses may be received from the one of the plurality of customers, via respective customer device (such as the first customer device 112A). In an example, the first set of textual conversations 106A of the first time-period may correspond to the first set of textual conversations 106A of the first agent 110A performed over the first time-period (say for a week). The processor 202 may retrieve the first set of textual conversations 106A (i.e. related to the first agent 110A) of the first time-period (for example of a particular week of a month) for generation of the behavioral information, related to the first agent 110A. With respect to Table 1, in case of the textual conversations of a month of January of 2019, a first exemplary textual conversation between the first agent 110A and the first customer 114A and a second exemplary textual conversation between the first agent 110A and the second customer 114B may be retrieved. In some embodiments, the processor 202 may retrieve the first set of textual conversations 106A based on the request received to generate the behavioral information of the first agent 110A. In such case, with respect to Table 1, the first exemplary textual conversation, the second exemplary textual conversation, and a fifth exemplary textual conversation related to the first agent 110A may be retrieved by the processor 202 from the stored plurality of textual conversations 106.

At block 306, the first set of features of each textual message in the first set of textual conversations 106A of the first time-period may be determined. In an embodiment, the processor 202 may be configured to determine the first set of features of each textual message in the retrieved first set of textual conversations 106A of the first time-period. The first set of features of each textual message may be determined based on natural language processing technique. In an example, a textual message in the first set of textual conversations 106A may correspond to one or more queries and one or more responses related to, but not limited to, a passport application. In such example (as shown in Table 1), the textual message may include a query by the first customer 114A, such as “First Customer: I need help with passport application process.”. The first agent 110A (i.e. customer service agent) may respond to the query with a response, such as “First Agent: Sure, could you please give me some details, such as your Date of Birth and Country of residence?” The words in the query and response included in the textual message such as “I”, “need”, “help”, “passport”, “please”, “details”, “country”, “residence” and so forth may be identified by the processor 202 with the use of the natural language processing technique.

In accordance with an embodiment, the processor 202 may be further configured to determine the first set of features for each textual message based on determination of a first plurality of weights associated with one or more words in each textual message of the retrieved first set of textual conversations 106A. Each word in the textual message may be assigned with a weight, for example, according to a relevance of the word in the query. In accordance with an embodiment, the processor 202 may be configured to apply, for example, a sentiment analysis on the one or more words extracted from each textual message in the retrieved first set of textual conversations 106A to determine the first plurality of weights. In an embodiment, a value of the first plurality of weights may vary between “0” to “1”. The sentiment analysis may assign a weight to each word, such as a higher weight to a more relevant word than a less relevant word. The sentiment analysis may also assign the higher weight to a more positive word than a less positive word. For example, the words in the query received from the first customer 114A “I need help with passport application process.” may be weighted in a manner, such that the word “need” may be assigned a higher weight than the word “with” in the query, as the word “need” may depict a requirement of the first customer 114A, whereas the word “with” may correspond to a connecting word that may be of less relevance than the word “need”. Similarly, the words in the response received from the first agent 110A, for example, “Sure, could you please give me some details, such as Date of Birth and Country of residence?” may be also weighted by the application of the sentiment analysis. In an example, the word “please” may be weighted more than the word “me”, as the word “please” may depict politeness or courtesy shown by the first agent 110A, as compared to the word “me” in the response of the textual message. Therefore, the word “please” may be consider a positive word than other words based on the application of the sentiment analysis on the exemplary response included in the textual message.

The processor 202 may be further configured to collate the determined weights of one or more words in the textual message, to determine the first plurality of weights for each textual message retrieved for the first time-period or related to a particular agent (such as the first agent 110A). For example, the first plurality of weights for each word included in the query of the abovementioned textual message may be: in the query: [0.01, 0.7, 0.48, . . . . , 0.401, 0.397], and for each word included in the response: [0.82, 0.33, 0.61, 0.93, 0.47, . . . , 0.78, 0.67].

In accordance with an embodiment, the first set of features may correspond to a vector representation for each textual message in the retrieved first set of textual conversations 106A. The vector representation may be associated with the first plurality of weights as well as word embeddings associated with each textual message of the first set of textual conversations 106A. The processor 202 may be configured to calculate the word embeddings by application of, but not limited to, an autoregressive model-based algorithm on each textual message. In accordance with an embodiment, the autoregressive model-based algorithm may be “XLNet”. The processor 202, with the application of the XLNet algorithm, may generate another plurality of weights (as the word embeddings) associated with one or more words in each textual message in the first set of textual conversations 106A. The XLNet algorithm may generate the other plurality of weights based on a semantic analysis and a syntactic analysis applied on each word. For example, the XLNet algorithm may utilize a bi-directional approach for understanding a contextual meaning of the textual message to generate a weight (i.e. one of the other plurality of weights) for each word in the textual message. In an example, in the response of the first agent 110A, i.e., “Sure, could you please give me some details, such as Date of Birth and Country of residence?” the XLNet algorithm may consider the words “Date of Birth” as a single entity to understand the context of the textual message and generate the weight for the word “Date of Birth”. In an example, the processor 202 may apply the XLNet algorithm to generate a higher weight for a positive word and a lower weight for a negative word. For example, positive words such as “please”, “thank you”, “happy” may be assigned a higher weight than negative words such as “don't disturb” and “I am busy” (as shown in Table 1).

Thus, the first plurality of weights and the other plurality of weights (i.e. word embeddings) may be determined for each word in the textual message, that may be further used to determine the vector representation of each word or sentences in the textual message. In an exemplary embodiment, the vector representation may be calculated based on a vector multiplication of the first plurality of weights and the other plurality of weights associated with one or more words in each textual message in the first set of textual conversations 106A. In an example, for the textual message “First customer: I need help with passport application process.” and the “First agent 110A: Sure, could you please give me some details, such as Date of Birth and Country of residence?”, the first plurality of weights may be multiplied with the other plurality of weights to determine the vector representation of the one or more words or the sentence in the textual message. Referring to the abovementioned example, for example, the first plurality of weights associated with the response of the first agent 110A may be [0.82, 0.33, 0.61, 0.93, 0.47, . . . , 0.78, 0.67] and the other plurality of weights maybe [0.7, 0.36, 0.55, 0.98, 0.45, . . . , 0.45, 0.75]. Therefore, the vector representation associated with the response of the first agent 110A may be [0.574, 0.118, 0.335, 0.911, 0.211, . . . , 0.351, 0.502]. For example, the vector representation [0.574, 0.118, 0.335, 0.911, 0.211, . . . , 0.351, 0.502] may represent as the first set of features (i.e. learned embeddings) for the textual message.

At block 308, a first creativity score for the first agent 110A may be determined based on the determined first set of features of the first set of textual conversations 106A. In an embodiment, the processor 202 may be configured to determine the first creativity score for the first agent 110A (for example the customer service agent) based on the determined first set of features. The first creativity score may indicate behavioral performance of the first agent 110A in providing responses to the queries received from the plurality of customers in the first time-period. For example, for the first time-period of one week, the first creativity score of the first agent 110A may indicate the behavior or performance of the first agent 110A for the textual conversations with the plurality of customers in the first time-period of the one week. In an example, the first agent 110A may communicate with the plurality of customers, such as 10 customers, in the first set of textual conversations 106A of the first time-period. Thus, in such example, the first set of textual conversations 106A may include 10 textual conversations of the first agent 110A with the 10 customers. The processor 202 may be configured to analyze each of the 10 textual conversations to determine the first set of features associated with each textual message of each of the 10 textual conversations, as described, for example, in step 306. In an example, considering a first set of textual messages (i.e. a first chat in Table 1) between the first agent 110A and the first customer 114A, the vector representation (i.e. the set of features) of the textual message (for example the response) of the first customer 114A may be [0.574, 0.118, 0.335, 0.911, 0.211, . . . , 0.351, 0.502]. Similarly, the processor 202 may determine the vector representation of the textual conversations between the first agent 110A and other customers (such as the second customer 114B) in the first set of textual conversations 106A.

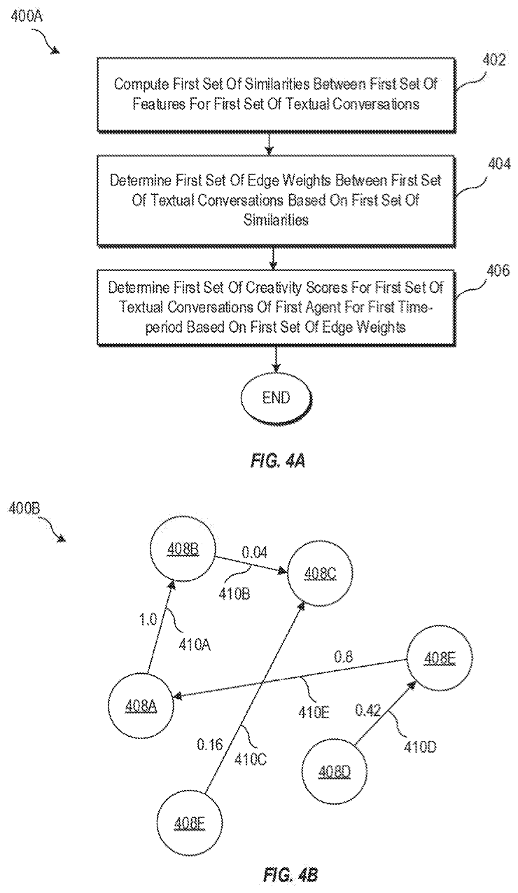

In an embodiment, the first creativity score may be determined based on the vector representations, (i.e., the first set of features) of each textual message in the first set of textual conversations 106A associated with the first agent 110A. The first creativity score may indicate an overall performance score or a behavioral score of the first agent 110A, for example, as a customer service agent. In an example, the first creativity score may be in a range of 0 to 1, such that a higher score may be generated for a more appreciable or for a good behavioral performance of the first agent 110A. For example, the first creativity score of “0.97” may be generated for the first agent 110A, in case the first agent 110A may have used polite and/or relevant words with the plurality of customers in most of the textual messages of the first set of textual conversations 106A, and/or the first agent 110A may have effectively resolved queries of the plurality of customers. In another example, the first creativity score of lower value (such as “0.28”) may be generated for the first agent 110A in case the first agent 110A may have used rude words with the plurality of customers in most of the textual messages of the first set of textual conversations 106A, and/or the first agent 110A may have left one or more queries of the customers unresolved. In an embodiment, the first creativity score may indicate an efficiency of the first agent 110A in resolving the queries or problems of the plurality of customers in the first time-period. In some embodiments, the first creativity score of the first agent 110A may indicate creativity and/or novelty in usage of words, or influence of the first agent 110A on other agents (such as the second agent 110B). Details of the determination of the first creativity score (i.e. indicating novelty and the influence) are further provided, for example, in FIGS. 4A, 4B, 5A, and 5B.

At block 310, the behavioral information, related to the first agent 110A, may be generated based on the determined first creativity score. In an embodiment, the processor 202 may be configured to generate the behavioral information of the first agent 110A based on the determined first creativity score. The behavioral information may correspond to an explanation of the first creativity score determined for the first agent 110A. For example, the behavioral information for the first agent 110A may indicate the explanation, in a particular language, of the first creativity score (i.e. achieved by the first agent 110A). In an embodiment, the language of the explanation may be based on geo-location or native language associated with the first agent 110A. In an example, for the first agent 110A the behavioral information may indicate that the first agent 110A used polite words such as “please”, therefore the first agent 110A may be a polite person and the performance of the first agent 110A may be good (or above a particular performance threshold) while communicating with the plurality of customers during the first time-period. In another example, for the first agent 110A, the behavioral information may indicate that the first agent 110A also inquired clearly about required details such as “Date of Birth” and “country of residence”. In another example, for the first agent 110A, the behavioral information may indicate that the first agent 110A may be rude in replying to the customer (i.e. not greeting the customers first), which may have led to determination of a low first creativity score of the first agent 110A. In some embodiment, the processor 202 may transmit the generated behavioral information to the first agent device 108A to further provide a feedback of the first set of textual conversations 106A to the first agent 110A, such that the first agent 110A may be motivated or may further work on enhancing own performance based on the first creativity score or generated behavioral information. In some embodiments, the generated behavioral information may include the determined first creativity score for the first agent 110A.

Control passes to end. Although the flowchart 300 is illustrated as discrete operations, such as 302, 304, 306, 308 and 310. However, in certain embodiments, such discrete operations may be further divided into additional operations, combined into fewer operations, or eliminated, depending on the particular implementation without detracting from the essence of the disclosed embodiments.

FIGS. 4A and 4B, collectively illustrate a flowchart of an example method for determination of a set of creativity score for a set of textual conversations, and illustrate an exemplary graph that depicts a first set of edge weights between the first set of textual conversations, respectively, according to at least one embodiment described in the present disclosure. FIG. 4A and FIG. 4B are explained in conjunction with elements from FIG. 1, FIG. 2 and FIG. 3. With reference to FIG. 4A, there is shown a flowchart 400A. The method illustrated in the flowchart 400A may start at 402 and may be performed by any suitable system, apparatus, or device, such as by the example electronic device 102 of FIG. 1 or the processor 202 of FIG. 2. For example, one or more of the electronic device 102, the first agent device 108A, the second agent device 108B, the Nth agent device 108N, the first customer device 112A, the second customer device 112B, or the Nth customer device 112N may perform one or more of the operations associated with the method. Although illustrated with discrete blocks, the steps and operations associated with one or more of the blocks of the method may be divided into additional blocks, combined into fewer blocks, or eliminated, depending on the particular implementation.

At block 402, a first set of similarities may be computed between the determined first set of features for the first set of textual conversations 106A. In an embodiment, the processor 202 may be configured to compute the first set of similarities between the first set of features determined for the first set of textual conversations 106A, for example, at step 306 in FIG. 3. In accordance with an embodiment, the first set of similarities may indicate an amount of similarity between each textual conversation of the first set of textual conversations 106A retrieved for the first agent 110A. For example, a higher similarity score may be assigned to a textual conversation that has more similar words when compared with another textual conversation. Similarly, a textual conversation, that has less similar words when compared with another textual conversation, may be assigned with a lower similarity score, than other textual conversation with higher similarity score. In an example, a first textual message may be created by the first agent 110A at a first time instant, a second textual message may be created by the first agent 110A at a second time instant, such that the second time instant occurs later than the first time instant. Similarly, there may be a third textual message which may be created for the first agent 110A at a third time instant, such that the third time instant may be later than the second time instant and the first time instant. In such a case, for example, the first textual message may include text “Sure Ma'am I am happy to help you. I would require a few details to assist you.”. The second textual message may include a text “Thank you for your patience, please provide us with required details so we can assist you better”. The third textual message may include a text “Ma'am we are happy to help, we require some details to assist you.” Therefore, the similar words in the first textual message and the second textual message may be “require”, “details”, “assist” and you”. The similar words in the third textual message as compared to the first textual message and the second textual message may be “Ma'am”, “happy”, “help”, “you”, “require”, “details”, and “assist”. Therefore, the third textual message may be assigned a higher similarity score than the second textual message, for example, based on more number of matched words. In an embodiment, the higher similarity score may indicate that the textual message may be less creative (or less novel) than the textual message with a lower similarity score.

In accordance with an embodiment, the processor 202 may be configured to compute the first set of similarities between the first set of textual conversations 106A based on, but not limited to, a cosine similarity function. The cosine similarity function may determine a cosine of an angle between the vectors (n-dimensional vectors) of the vector representation (i.e. the first set of features) of the two textual messages of the first set of textual conversations 106A. In an example, the cosine of the angle may be computed based on a dot product of the vectors (for example a vector A and a vector B) in the vector representation divided by a length of the two vector representations of the two textual messages as per equation (1) below:

$$Similarity ( A , B ) = \frac{A \cdot B}{{\vert A \vert}^{*} \vert B \vert} \qquad ( 1 )$$

In an example, the processor 202 may be configured to compute the first set of similarities based on frequency of each word in the textual message. In accordance with an embodiment, the first set of similarities may be computed based on an average of the occurrence of the matched words in the textual message. In an example, if a word, such as “details” occurs thrice in a textual conversation, whereas a word “please” occurs once in the textual message, then the word “details” may be weighted more in the textual message whereas the word “please” may be weighted with a lesser value. The first set of similarities may be determined based on the weighted average of the matched words, such as words “details” and “please”.

At block 404, a first set of edge weights between the first set of textual conversations 106A of the first agent 110A may be determined, based on the computed first set of similarities. The processor 202 may be configured to determine the first set of edge weights between the first set of textual conversations 106A based on the computed first set of similarities. In an embodiment, the first set of textual conversations 106A for the first agent 110A may be represented by a plurality of nodes in a graph (shown in FIG. 4B). The first set of edge weights may be determined for each edge between the plurality of nodes. An exemplary graph that depicts the first set of edge weights between the first set of textual conversations 106A of the first agent 110A is shown, for example, in FIG. 4B. With respect to FIG. 4B, there is shown a graph 400B that may include the first set of edge weights determined between the first set of textual conversations 106A of the first agent 110A (i.e. for example one customer service agent). The first set of textual conversations 106A may be represented as the plurality of nodes, such as a first node 408A, a second node 408B, a third node 408C, a fourth node 408D, a fifth node 408E and a sixth node 408F, as shown in FIG. 4B. Moreover, edges between the plurality of nodes may be represented as a first edge 410A, a second edge 410B, a third edge 410C, a fourth edge 410D and a fifth edge 410E. The first set of edge weights may indicate creativity (for example novelty) of each textual conversation over others in the first set of textual conversations 106A. In an example, each node of the plurality of nodes may indicate a textual conversation of the first agent 110A in the first time-period. In an exemplary embodiment, a higher edge weight between two nodes (i.e. the textual conversations) may indicate that a prior node of the two nodes is more creative than a subsequent node of the two nodes. Therefore, the prior node may possess a similarity score that may be less than a similarity score of the subsequent node (or textual message). On other hand, a lower edge weight between two nodes (the textual conversations) may indicate that a prior node of the two nodes is less creative than a subsequent node of the two nodes. Therefore, the prior node may possess a similarity score that may be more than a similarity score of the subsequent node.

The plurality of nodes (or number of the first set of textual conversations 106A) in the graph 400B may be denoted by P={pᵢ=1, 2, . . . , N} and may include a timestamp t(pᵢ). Any two nodes, for example the first node 408A and the second node 408B may be connected by an edge directing towards the second node 408B if the second node 408B is created after the creation of the first node 408A. As shown in FIG. 4B, the first edge 410A may be connected between the first node 408A and the second node 408B, directing towards the second node 408B. Similarly, the second edge 410B may be connected between the second node 408B and the third node 408C, directing towards the third node 408C. The third edge 410C may be connected between the third node 408C and the sixth node 408F, directing towards the third node 408C. The fourth edge 410D may be connected between the fourth node 408D and the fifth node 408E, directing towards the fifth node 408E. The fifth edge 410E may be connected between the first node 408A and the fifth node 408E, first node 408A, as shown in FIG. 4B. It may be noted that six nodes in the plurality of nodes in FIG. 4B are presented merely as an example. The plurality of nodes or the textual conversation include in the first set of textual conversations 106A for the first agent 110A or the first time-period may include any number of textual conversations, without any deviation from the scope of the disclosure.

In an embodiment, an edge weight (i.e. one of the first set of edge weights) may be denoted as wᵢⱼ. Further, “W” may denote a weight adjacency matrix, where Wᵢⱼ=wᵢⱼ if there is an edge from a node pᵢ to a node pⱼ, else Wᵢⱼ=0. Moreover, wᵢⱼ=S(pᵢ, pⱼ) if t(pᵢ)<t(pⱼ); where S(pᵢ, pⱼ) depicts a similarity between the two nodes (or the vector representation or the first set of features for the two nodes or textual messages) and ‘t’ may represent the time instant at which the particular node or textual message may be created. In accordance with an embodiment, an initial first set of edge weights may be selected as random weights which may be further updated based on execution of step 404 by the processor 202.

As shown in FIG. 4B, a first edge weight “1.0” of the first edge 410A may imply that the first node 408A (for example a first textual conversation of the first agent 110A) may be more creative than the second node 408B (for example a second textual conversation of the first agent 110A), as the first edge weight is of higher weight (“1.0”) and the first edge 410A is directed from the first node 408A to the second node 408B. A second edge weight “0.04” of the second edge 410B may imply that the second node 408B may be less creative than the third node 408C. A third edge weight “0.16” of the third edge 410C may imply that the sixth node 408F may be less creative than the third node 408C. A fourth edge weight “0.42” of the fourth edge 410D may imply that the fourth node 408D may be less creative than the fifth node 408E. A fifth edge weight “0.8” of the fifth edge 410E may imply that fifth node 408E may be more creative than the first node 408A. Therefore, the graph 400B may indicate effect of the prior textual conversation of the first agent 110A on the subsequent textual conversation of the same agent (i.e. first agent 110A), as the determination of the first set of edge weights may be based on the first set of features as well as the first set of similarities between the first set of textual conversations 106A of a particular time-period (such as the first time-period). The influence of one node (i.e. textual conversation of one agent) on another node (i.e. textual conversation of another agent) is described, for example, in FIGS. 5A and 5B.

Referring back to FIG. 4A, at block 406, a first set of creativity scores may be determined for the first set of textual conversations 106A of the first agent 110A for the first time-period, based on the determined first set of edge weights. In an embodiment, the processor 202 may be configured to determine the first set of creativity scores for the first set of textual conversations 106A based on the first set of edge weights determined at step 404. The first set of creativity scores may be an indicative of a creativity of each textual conversation of the first agent 110A and an influence of a prior textual conversation on the subsequent textual conversation. For example, the textual conversation represented by the first node 408A may be created before the textual conversation represented by the second node 408B (as shown in FIG. 4B) and the first edge weight “1.0” of the first edge 410A points towards the second node 408B. In such a scenario, the first node 408A may considered to be more creative and novel. Further, as the similarity score for the second node 408B may be more than the similarity score of the first node 408A, the first node 408A may be considered to influence the creation of the second node 408B. Therefore, a creativity score of the textual conversation represented by the first node 408A may be of a higher value than a creativity score of the textual conversation represented by the second node 408B. In an exemplary embodiment, the creativity score of the textual message may in a range of “0” to “1”. The first set of creativity scores may be the collective creativity scores for of the first set of textual conversations 106A in the first time-period (for example last one month) for the first agent 110A. Referring to FIG. 4B, the first set of creativity scores may include the creativity score of each textual conversation represented by the plurality of nodes in the graph 400B.

In accordance with an embodiment, the creativity score (i.e. included in the first set of creativity scores) of each textual conversation (such the node (pᵢ)) may be determined by the processor 202, by using a following equation 2:

C(pᵢ)=(1−α)/N+αΣⱼwᵢⱼC(pⱼ)/N(pⱼ) (2)

where 0<α<1 and N(pⱼ)=Σₖwₖⱼ

C(pᵢ) represents a creativity score for the node pᵢ. The term a represents a fraction of the first set of edge weights from an outgoing edge of the node pᵢ. The term N represents a normalization term for the node pᵢ. The term wᵢⱼ represents the adjacency matrix of the graph (such as the graph 400B).

A constant term (1−α)/N may indicate that a similarity between the two nodes (or the textual conversations) may not necessarily mean that the subsequent node is influenced by the prior node. For example, words like “Hello”, “Good Morning”, and the like may be considered as generic words (or repetitive words) in the textual conversations, and occurrence of such words may not be accounted for computation of the first set of similarities and the creativity score.

The term N(pⱼ) may be a sum of all the incoming weights for the node “j”. Thus, a contribution of the node pⱼ may be a split among the incoming nodes based on the edge weights, and hence, the node pᵢ may collect a fraction wᵢⱼ/Σₖwₖⱼ of the creativity score of the node pⱼ. Moreover, the equation 2 may be represented as:

C=(1−α)/N*1+αWC (3)

where W represents a column stochastic matrix defined as Wᵢⱼ=wᵢⱼ/Σₖwₖⱼ. The constant “1” represents a column vector with value “1”. Furthermore, the first set of creativity scores may be determined by the processor 202 by iterating the equation 3 until convergence is achieved.

Control passes to end. Although the flowchart 400A is illustrated as discrete operations, such as 402, 404 and 406. However, in certain embodiments, such discrete operations may be further divided into additional operations, combined into fewer operations, or eliminated, depending on the particular implementation without detracting from the essence of the disclosed embodiments.

In accordance with an embodiment, the processor 202 may be further configured to calculate the first creativity score for the first agent 110A (as described in step 308 in FIG. 3 based on the first set of creativity scores determined for the first set of textual conversations 106A of the first agent 110A at step 406 in FIG. 4. In some embodiments, the processor 202 may calculate an average or an arithmetic mean of the determined first set of creativity scores to calculate the first creativity score for the first agent 110A, which may be further utilized to generate the behavioral communicative information for the first agent 110A, as described, for example, at step 310 in FIG. 3. In some embodiments, the processor 202 may calculate a harmonic mean or a geometric mean of the determined first set of creativity scores to calculate the first creativity score for the first agent 110A or other agents/customers.

FIG. 5A and FIG. 5B illustrates a flowchart of an example method for determination of a first creativity score for the first agent and a second creativity score for a second agent for the generation of the behavioral information, and illustrates an exemplary graph that depicts the set of edge weights between the plurality of textual conversations of plurality of agents, respectively, according to at least one embodiment described in the present disclosure. FIG. 5A and FIG. 5B are explained in conjunction with elements from FIG. 1, FIG. 2, FIG. 3, FIG. 4A and FIG. 4B. With reference to FIG. 5A, there is shown a flowchart 500A. The method illustrated in the flowchart 500A may start at 502 and may be performed by any suitable system, apparatus, or device, such as by the example electronic device 102 of FIG. 1 or the processor 202 of FIG. 2. For example, one or more of the electronic device 102, the first agent device 108A, the second agent device 108B, the Nth agent device 110N, the first customer device 112A, the second customer device 112B, or the Nth customer device 112N may perform one or more of the operations associated with the method. Although illustrated with discrete blocks, the steps and operations associated with one or more of the blocks of the method may be divided into additional blocks, combined into fewer blocks, or eliminated, depending on the particular implementation.

At block 502, a second set of textual conversations 106B of a second time-period may be retrieved from the stored plurality of textual conversations 106. In an embodiment, the processor 202 may be configured to retrieve the second set of textual conversations 106B of the second time-period from the memory 204, the persistent data storage 206, or the database 104. The second set of textual conversations 106B may correspond to or may be communicated by the second agent 110B (for example the second customer service agent) of the plurality of agents. The second set of textual conversations 106B may include the plurality of textual messages shared between the second agent 110B and the plurality of customers (for example the first customer 114A, or the second customer 114B) as described, for example, in Table 1 in FIG. 3. In an embodiment, the second time-period may correspond to a time period in which the second set of textual conversations 106B may be created or communicated. In some embodiments, the second time-period may be same as the first time-period (such as last one month). In accordance with an embodiment, the processor 202 may be further configured determine the second set of features for the second set of textual conversations 106B related to the second agent 110B. The processor 202 may determine the second set of features (i.e. for the second set of textual conversations 106B) in form of the vector representation based on the determination of the first plurality of weights by use of the sentiment analysis and the other plurality of weights by use of the XLNet algorithm, as described, for example, in step 306 of FIG. 3 for the first set of textual conversations 106A of the first agent 110A. Similarly, the processor 202 may determine the Nth set of features (i.e. for the Nth set of textual conversations 106N of the plurality of agents) in form of the vector representation based on the determination of the plurality of weights by use of the sentiment analysis, and the other plurality of weights by use of the XLNet algorithm, as described, for example, in step 306 of FIG. 3 for the first set of textual conversations 106A of the first agent 110A.

At block 504, a second set of edge weights may be determined between the first set of textual conversations 106A of the first agent 110A and the second set of textual conversations 106B of the second agent 110B. The processor 202 may be configured to determine the second set of edge weights between the first set of textual conversations 106A of the first agent 110A and the second set of textual conversations 106B of the second agent 110B. In some embodiments, the second set of edge weights may be determined between corresponding textual messages of each of the plurality of agents, like each of the first agent 110A, the second agent 110B, and the Nth agent 110N (for example between all the customer service agents). In some embodiments, the second set of edge weights may be determined between the textual conversations of each of the plurality of customers. With respect to FIG. 5B, each textual conversation of the plurality of textual conversations 106 (like the first set of textual conversations 106A and the second set of textual conversations 106B) may be represented by a node of a plurality of nodes. The second set of edge weights may be determined for each edge between the plurality of nodes. FIG. 5B illustrates an exemplary graph 500B that depicts the second set of edge weights between a textual message of a textual conversation (i.e. one of the plurality of textual conversations 106) of one or more of the plurality of agents for a first time instant. The second set of edge weights may indicate creativity (for example novelty) of each textual conversation of the plurality of textual conversations 106 created for the first time instant. In an example, each node of the plurality of nodes may indicate a textual message or a textual conversation of a particular agent of the plurality of agents, such as a node for a textual conversation of the first agent 110A created in the first time instant and another node for a textual conversation of the second agent 110B created in the same time instant. In an exemplary embodiment, a higher edge weight between two nodes (the textual conversations) may indicate that a prior node of the two nodes is more creative than a subsequent node of the two nodes. As described at step 404 of FIG. 4A and FIG. 4B, the prior node (with higher creativity score) may possess a similarity score that is less than a similarity score of the subsequent node. Moreover, a lower edge weight between two nodes (the textual conversations) may indicate that a prior node of the two nodes is less creative than a subsequent node of the two nodes. The second set of edge weights between the plurality of nodes may also indicate influence (such as a positive influence or a negative influence) of one node on another node of the plurality of nodes. For example, one of the first set of textual conversations 106A of the first agent 110A represented by a node may influence one of the second set of textual conversations 106B of the second agent 110B in a positive manner, so that the second agent 110B may use polite words with the plurality of customers, by learning from the words used in the first set of textual conversations 106A of the first agent 110A. Moreover, a higher edge weight between the two nodes may indicate that the influence of a prior node (for example, the node that depicts one or more of the first set of textual conversations 106A of the first agent 110A) is positive on a subsequent node (for example, the node that depicts one or more of the second set of textual conversations 106B of the second agent 110B). Thus, the prior node may be considered to be more influential than the subsequent node.

As shown in FIG. 5B, for example, the plurality of textual conversations 106 of the plurality of agents may be represented as the plurality of nodes, such as a first node 516, a second node 518, a third node 520, a fourth node 522, a fifth node 524, and a sixth node 526. Moreover, edges between the plurality of nodes may be represented as a first edge 528A, a second edge 528B, a third edge 528C, a fourth edge 528D and a fifth edge 528E.

In an embodiment, each of the plurality of nodes in the graph 500B may represent at least one textual conversation or textual message of each of the plurality of agents. For example, the first node 516 may represent one of the first set of textual conversations 106A for the first agent 110A created at the first time instant and the second node 518 may represent one of the second set of textual conversations 106B for the second agent 110B created at the first time instant. Similarly, the third node 520, the fourth node 522, the fifth node 524, and the sixth node 526 may indicate corresponding textual conversations (i.e. chats of a particular time instant) related to different agents of the plurality of agents.

In accordance with an embodiment, the processor 202 may be configured to determine the features for each textual message of a particular agent (i.e. indicated by the node of the graph 500B). The determination of the features (i.e. vector representation) of the textual message is described, for example, at step 306 in FIG. 3. The processor 202 may be further configured to compute the similarities between the determined features of different textual conversations (i.e. of the first time instant) created by the plurality of agents. The computation of the similarities between the features of textual conversations is described, for example, at step 402 in FIG. 4. In accordance with an embodiment, the processor 202 may be further configured to determine the second set of edge weights based on the computed similarities between the textual conversations of different agents (for example the first agent 110A and the second agent 110B). The determination of the second set of edge weights may be similar to the determination of the first set of edge weights as described, for example, at step 404 in FIG. 4.

In an embodiment, the second set of edge weights between the plurality of nodes may indicate the novelty of the textual conversation represented by each node of the plurality of nodes. Moreover, the second set of edge weights between the plurality of nodes may indicate the influence of the textual conversation of one agent (for example, the first agent 110A) on another agent (for example, the second agent 110B) for the first time instant. In an example, the first edge 528A may indicate a contribution of an agent (for example, the first agent 110A) in positively influencing another agent (for example, the second agent 110B), in case the weight of the first edge 528A is of a higher value (for example closer to 1.0).

Any two nodes, for example the first node 516 and the second node 518 may be connected by an edge directing towards the second node 518 if the second node 518 is created after the creation of the first node 516 in the first time instant. Similarly, the plurality of edges may be connected between the plurality of nodes and directed towards any one node of the plurality of nodes based on time of creation of the plurality of nodes. For example, the plurality of nodes, shown in FIG. 5B, may include a textual conversation (such as one chat) between one or more of the plurality of agent of a particular time instant (like the first time instant).

As shown in FIG. 5B, a first edge weight “0.92” (one of the second set of edge weights) of the first edge 528A may imply that the first node 516 (for example one of the first set of textual conversations 106A for the first agent 110A) may be more creative than the second node 518 (for example one of the second set of textual conversations 106B for the second agent 110B). Moreover, the first edge weight “0.92” may imply that the first node 516 may be more influential (such as in the positive manner) than the second node 518. A second edge weight “0.02” of the second edge 528B may imply that the second node 518 (i.e. denotes one of the second set of textual conversations 106B may be less creative than the third node 520 (i.e. denotes one of set of textual conversations or messages of a third agent). Further, the second edge weight “0.02” may also imply that the second node 518 may be less influential (such as in the positive manner) than the third node 520. A third edge weight “0.38” (i.e. one of the second set of edge weights) of the third edge 528C may imply that the sixth node 526 is less creative and less influential than the third node 520. A fourth edge weight “0.94” of the fourth edge 528D may imply that the fourth node 522 is more creative and more influential than the fifth node 524. A fifth edge weight “0.4” of the fifth edge 528E may imply that fifth node 524 is less creative and less influential than the first node 516. Thus, the graph 500B may indicate the effect (or influence) of the textual conversation of a particular agent (such as the first agent 110A) on the subsequent agent (such as the second agent 110B), as the determination of the second set of edge weights may be based on comparison or correlation between the set of features (as well as a set of similarities) of different textual messages associated with different agents or customers (i.e. plurality of nodes in FIG. 5B). The determination of edge weights based on set of similarities and the set of features of the textual message is described, for example, at step 402 and 404 in FIG. 4B.

Referring to FIG. 5A, at block 506, a second set of creativity scores may be determined for the second set of textual conversations 106B retrieved for the second time-period, based on the determined second set of edge weights. The processor 202 may be configured to determine the second set of creativity scores for the second set of textual conversations 106B of the second agent 110B, based on the edge weights corresponding to the second agent 110B in determined second set of edge weights. In accordance with an embodiment, the processor 202 may be configured to generate the graph 500B where one of the plurality of nodes (for example the second node 518) may depict at least one textual conversation of the second set of textual conversations 106B of the second agent 110B.

The one of the second set of creativity scores may be indicative of a creativity of each textual conversation of the second agent 110B and an influence of the corresponding textual conversation of the second agent 110B on other agents of the plurality of agents. For example, textual messages of a polite agent (such as the first agent 110A) may have higher influence (and higher creativity score) on another agent (such as the second agent 110B) or on textual messages of the other agent.

In accordance with an embodiment, the graph 500B may be created for multiple time instants. In an example, a first graph may be created for multiple textual conversations of the plurality of agents for the first time instant. Further, a second graph may be created for other textual conversations of the plurality of agents for a second time instant. Similarly, an Nth graph may be created for textual conversations of the plurality of agents for Nth time instant. In another embodiment, the first graph may be updated for each textual conversation of the particular agent (like customer service agent) over the time so that all the plurality of textual conversations 106 or all retrieved textual conversations of the plurality of agents may be considered to form the final graph. Thus, for each agent of the plurality of agents (for example, the first agent 110A, the second agent 110B and the Nth agent 110N), the plurality of creativity scores may be generated over the time based on the comparison of different retrieved textual conversations of multiple time instants of different agents. For example, different textual conversations of multiple time instants may be referred as the first set of textual conversations 106A for the first agent 110A and the second set of textual conversations 106B for the second agent 110B. The determination of a creativity score based on determination of edge weights between textual conversations (i.e. either of same or different agents) is described, for example, at step 406 in FIG. 4. Similarly, the processor 202 may be configured to determine the second set of creativity scores over the time for the retrieved second set of textual conversations 106B of the second agent 110B, based on the corresponding edge weights (i.e. related to the edges of the second agent 110B) in the second set of edge weights of the plurality of agents. Similarly, the processor 202 may be configured to determine the first set of creativity scores over the time for the retrieved first set of textual conversations 106A of the first agent 110A, based on the corresponding edge weights (i.e. related to the edges of the first agent 110A) in the second set of edge weights of the plurality of agents. In an embodiment, the processor 202 may determine a set of creativity scores for the retrieved textual conversations of the plurality of agents, based on the corresponding edge weights in the second set of edge weights evaluated over the time for the plurality of agents (like different customer service agents).

Examples of the set of creativity scores for different agents over an evaluation time are presented in Table 2, as follows:

TABLE 2
Examples of set of creativity scores for
different agents over an evaluation time

| | Creativity Scores of an agent for |
|---|---|
| Agent | different messages over a time range |
| First Agent | [0.92, 0.86, 0.98, 0.85, 0.79] |
| Second Agent | [0.01, 0.34, 0.08, 0.245, 0.544, 0.121, |
| | 0.797, 0.047, 0.4] |
| Nth Agent | [0.87, 0.0.3, 0.879, 0.954, 0.376, 0.765, |
| | 0.398, 0.96, 0.8, 0.57, 0.211] |

In an exemplary embodiment, the first set of creativity scores may be represented as an exemplary vector [0.92, 0.86, 0.98, 0.85, 0.79], for five number of textual conversations of the first agent 110A. The second set of creativity scores may be represented as an exemplary vector [0.01, 0.34, 0.08, 0.245, 0.544, 0.121, 0.797, 0.047, 0.4] for nine number of textual conversations of the second agent 110B. Similarly, the Nth set of creativity scores may be represented as an exemplary vector [0.87, 0.0.3, 0.879, 0.954, 0.376, 0.765, 0.398, 0.96, 0.8, 0.57, 0.211] for eleven number of textual conversations of the Nth agent 110N. The plurality of creativity scores for the plurality of agents (as depicted in Table 2) may indicate the creativity as well as the influence of each agent on other agent in the plurality of agents. The plurality of creativity scores for the plurality of agents may be determined based on the determined second set of edge weights evaluated between the retrieved plurality of textual conversations 106 of the plurality of agents (for example customer service agents).

At block 508, a set of similarities may be determined between the first set of creativity scores for the first agent 110A for the first time-period and the second set of creativity scores for the second agent 110B for the second time-period. In an embodiment, the processor 202 may be configured to determine the set of similarities between the first set of creativity scores for the first agent 110A and the second set of creativity scores for the second agent 110B. For example, the first set of creativity scores for the first agent 110A, the second set of creativity scores for the second agent 110B, or a set of creativity scores for Nth agent are indicated in Table 2. Referring to Table 2, a length of the vector representation of a set of creativity scores for different agents may vary from each other. For example, the length of the vector representation of the first set of creativity score may be five, the length of the vector representation of the second set of creativity score may be nine and the length of the vector representation of the Nth set of creativity score may be eleven, as shown in Table 2.

In order to fairly access and compare all creativity scores of the plurality of agents (such as the first agent 110A, the second agent 110B and the Nth agent 110N), and determine the first creativity score of the first agent 110A, a second creativity score of the second agent 110B and an Nth creativity score of the Nth agent 110N, the processor 202 may be configured to determine the set of similarities between the corresponding creativity scores of different agents. In accordance with an embodiment, the processor 202 may apply a dynamic time warping (DTW) function on the determined sets of creativity scores (for example on the vector representation of the first set of creativity scores and the second set of creativity scores) to determine the set of similarities or distance between the sets of creativity scores related to the plurality of agents. With the use of the dynamic time warping function, the processor 202 may consider vector representation (such as the first set of creativity scores) for the first agent 110A and the vector representation (such as the second set of creativity scores) for the second agent 110B to determine a similarity or distance between two vector representations of the creativity scores. The vector representations may be non-linearly “warped” in a time-dimension to determine the set of similarities between the vector representations.

In an embodiment, the processor 202 may apply the dynamic time warping function to compare the two vector representations (such as the first set of creativity scores and the second set of creativity scores) to determine a difference or distance between the corresponding scores of the two vector representations. In some embodiments, the processor 202 may apply the dynamic time warping function to compare the creativity scores with analysis of point-to-point alignment between different creativity scores in the vector representations (for example as indicated in Table 2). For example, the first set of creativity scores of the first agent 110A may be considered in Y-axis and the second set of creativity scores of the second agent 110B may be considered on X-axis (or vice-versa) of a two-dimensional distance matrix, to analyze the point-to-point alignment, and compare the vector representations (i.e. all the creativity scores of two agents) to determine the difference or distance between the two vector representations of the creativity scores. In an embodiment, the difference or distance between different values of the vector representations of the creativity scores may be determined based on equation (4):

DTW(i,j)=[Xi−Yi]+min(DTW(i,j−1),DTW(i−1,j),DTW(i,j)) (4)

where X=(X1, X2, . . . , Xn) as first time series of the first set of creativity scores for the first agent 110A, and Y=(Y1, Y2, . . . , Ym) as second time series of the second set of creativity scores for the second agent 110A as shown in Table 2,

i=0 to n and j=0 to m, where n is the length of X series and m is the length of Y series, and n and m are different from each other,

DTW (0, 0)=0, DTW (n, 0)=infinity, and DTW (0, m)=infinity, and

DTW may indicate a distance between two values of the X series and the Y series of creativity scores to determine a two-dimensional distance matrix.

In an embodiment, the processor 202 may apply the dynamic time warping function on the first time series (X) and the second time series (Y) to determine all distance (DTW) values for the two-dimensional distance matrix. The processor 202 may further select best values/points (i.e. starting from last point to first point) from the determined distance matrix. In an embodiment, the selected best values/points may satisfy a minimal value function between multiple DTW values (like four values). The processor 202 may further calculate a sum of the selected best values/points to determine the distance or difference (or an optimal match) between the two series of creativity scores. In an embodiment, a higher difference between the vectors of creativity score may indicate a lower similarity between the two vector representations of creativity scores.

The processor 202 may determine the distance or similarity between each set of creativity scores of the plurality of agents, to determine the set of the similarities between the textual conversation of the plurality of agents. The determination of the set of similarities, by the disclosed electronic device 102, may enable understanding of evolution of creativity in textual conversations of the plurality of agents, such as the first agent 110A or the second agent 110B. Moreover, by the determined set of similarities, the disclosed electronic device 102 may enable comparison between performance of the plurality of agents, such as the first agent 110A and the second agent 110B over the time. In an example, the set of similarities may indicate influence of the plurality of agents on each other. For example, in case of a higher similarity between the first set of creativity scores of the first agent 110A and the second set of creativity scores of the second agent 110B, then the second agent 110B may be considered to be influenced by the first agent 110A. The dynamic time warping function applied by the processor 202 may enable determination of the set of similarities between the sets of creativity scores even when the length of the vector representation of the plurality of creativity scores are different. In some embodiment, the processor 202 may apply the dynamic time warping function to output a cumulative difference between the vector representations of the sets of creativity scores of the plurality of agents.

At block 510, the first creativity score for the first agent 110A may be determined based on the determined set of similarities. In accordance with an embodiment, the processor 202 may be configured to determine first creativity score for the first agent 110A based on the set of similarities determined based on the application of the dynamic time warping function (DTW). The set of similarities determined by the dynamic time warping function may indicate the creativity and the influence of the first agent 110A on the other agents, or vice-versa. For example, the determined set of similarities may be higher if the first agent 110A is influenced more by the other agents of the plurality of agents and thus may be less creative. Therefore, the first creativity score for the first agent 110A may be lower, based on the determination of less creativity of the first agent 110A and less influence of the first agent 110A on other agents of the plurality of agents. In other words, the first creativity score of the first agent 110A may be of higher value, when the determined distance between the creativity scores (step 508) is of higher value, and the similarities between the creativity scores is of lower value. In another example, the first creativity score for the first agent 110A may be higher if the first agent 110A positively influences the second agent 110B (for example, the second agent 110B may use polite words as used by the first agent 110A). Thus, the first creativity score may be indicative of the creativity or novelty of the first agent 110A in the textual conversation, and an indicative of the influence the first agent 110A on other agents of the plurality of agents.

At block 512, a second creativity score may be determined for the second agent 110B based on the determined set of similarities. In accordance with an embodiment, the processor 202 may be configured to determine the second creativity score for the second agent 110B based on the set of similarities determined based on the application of the dynamic time warping function (DTW). The set of similarities determined by the dynamic time warping function may indicate the creativity and the influence of the second agent 110B on the other agents, or vice-versa. For example, the determined set of similarities may be lower if the second agent 110B influences other agents of the plurality of agents and thus may be more creative. Therefore, the second creativity score for the second agent 110B may be higher, based on the determination of more creativity of the second agent 110B and more influence on other agents of the plurality of agents. In an example, the second creativity score for the second agent 110B may be lower if the second agent 110B negatively influences the first agent 110A. Thus, the second creativity score may be indicative of the creativity of the second agent 110B and the influence the second agent 110B may have on the plurality of agents.

Similarly, an Nth creativity score may be determined for the Nth agent 110N based on the set of similarities determined at step 508. Furthermore, based on the determination of the set of similarities between the creativity scores vectors, and determination of respective creativity score for each agent (i.e. customer service agent), the disclosed electronic device 102 may provide enhanced and automatic evaluation of the textual messages of the plurality of agents over the time, and may also determine an outlier in the plurality of agents, for example, an agent with a lowest creative score and an agent with a highest creativity score. Further, with the automatic and quantative determination of features vectors, similarities, edge weights, and/or creativity scores, the disclosed electronic device 102 may provide fine grained assessment of the plurality of textual conversations 106 or assessment of the plurality of agents or the plurality of customers.

At block 514, behavioral information of the first agent 110A and the second agent 110B may be generated based on the first creativity score and the second creativity score, respectively. In accordance with an embodiment, the processor 202 may be further configured to generate the behavioral information related to the first agent 110A and the second agent 110B based on the first creativity score and the second creativity score, respectively. The behavioral information may correspond to an explanation of the first creativity score of the first agent 110A and the second creativity score generated for the second agent 110B. For example, the behavioral information may be generated such that there may be fair assessment of the first set of textual conversations 106A and the second set of textual conversations 106B. In an example, for a response “Have a great day Sir”, included in a textual conversation of the first agent 110A, the disclosed electronic device 102 may output the behavioral information such as: “The first agent 110A was polite and courteous in responding to the customer”. In another example, for the response “I am busy, do not disturb” of the second agent 110B, the disclosed electronic device 102 may automatically evaluate such response and output the behavioral information such as: “The second agent 110B used rude words such as “do not disturb” and did not resolve customer's query”. In an embodiment, the behavioral information may also provide a feedback of the first set of textual conversations 106A and the second set of textual conversations 106B to the first agent 110A and the second agent 110B. It may be noted that the behavioral information provided by the disclosed electronic device 102 may enable the plurality of agents (for example the customer service agents) to work effectively on the enhancement of own performance and textual conversations. In another example, one or more agents or customers with negative feedback or rude behavioral performance (low creativity score) may be penalized.

Control passes to end. Although the flowchart 500A is illustrated as discrete operations, such as 502, 504, 506, 508, 510, 512 and 514. However, in certain embodiments, such discrete operations may be further divided into additional operations, combined into fewer operations, or eliminated, depending on the particular implementation without detracting from the essence of the disclosed embodiments.

In accordance with an embodiment, the method may also include evaluation of the performance of the plurality of agents in terms of other metrics, such as, but not limited to precision of messages, time to response, and customer feedback in addition to the determination of the creativity scores. In an embodiment, the plurality of textual conversations 106 of the plurality of agents may correspond to a same language. In another embodiment, one or more of the plurality of textual conversations 106 may correspond to different languages (for example, but not limited to, English, French, German, Chinese, or Japanese).

It may be further noted that, in addition to the assessment of the plurality of agents based on the analysis of the textual conversations, the disclosed electronic device 102 may be utilized in different applications, such as, but not limited to, assessment of learnings of disable people or autistic children, assessment of body movement in various sports activities, or assessment of people with analysis of image, speech, and/or audio data.

Various embodiments of the disclosure may provide one or more non-transitory computer-readable storage media configured to store instructions that, in response to being executed, cause an electronic device (such as the example electronic device 102) to perform operations. The operations may include storing a plurality of textual conversations. Each textual conversation of the plurality of textual conversations corresponds to a plurality of textual messages shared between a plurality of agents and a plurality of customers. The operations may further include retrieving a first set of textual conversations of a first time-period from the stored plurality of textual conversations. The first set of textual conversations correspond to a first agent of the plurality of agents. Furthermore, the operations may include determining a first set of features of each textual message in the retrieved first set of textual conversations of the first time-period. The operations may further include determining a first creativity score for the first agent based on the determined first set of features of the first set of textual conversations. Moreover, the operations may include generating behavioral information, related to the first agent, based on the determined first creativity score.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In this description, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
storing a plurality of textual conversations, wherein each textual conversation of the plurality of textual conversations corresponds to a plurality of textual messages shared between a plurality of agents and a plurality of customers;
retrieving a first set of textual conversations of a first time-period from the stored plurality of textual conversations, wherein the first set of textual conversations correspond to a first agent of the plurality of agents;
determining a first set of features of each textual message in the retrieved first set of textual conversations of the first time-period;
determining a first creativity score for the first agent based on the determined first set of features of the first set of textual conversations; and
generating behavioral information, related to the first agent, based on the determined first creativity score.

2. The method according to claim 1, wherein the determining the first set of features for each textual message is based on determination of a first plurality of weights associated with one or more words in each textual message in the retrieved first set of textual conversations.

3. The method according to claim 2, further comprising applying a sentiment analysis on the one or more words in each textual message in the retrieved first set of textual conversations to determine the first plurality of weights.

4. The method according to claim 1, wherein the determined first set of features correspond to a vector representation for each textual message in the retrieved first set of textual conversations.

5. The method according to claim 1, further comprising:
determining a first set of edge weights between the first set of textual conversations of the first agent based on the determined first set of features for the first set of textual conversations; and
determining a first set of creativity scores for the first set of textual conversations of the first agent for the first time-period, based on the determined first set of edge weights.

6. The method according to claim 5, further comprising:
computing a first set of similarities between the determined first set of features for the first set of textual conversations; and
determining the first set of edge weights between the first set of textual conversations of the first agent based on the computed first set of similarities.

7. The method according to claim 6, wherein the first set of similarities are computed based on a cosine similarity function.

8. The method according to claim 1, further comprising:
retrieving a second set of textual conversations of a second time-period from the stored plurality of textual conversations; wherein the second set of textual conversations correspond to a second agent of the plurality of agents; and
determining a second set of edge weights between the first set of textual conversations of the first agent and the second set of textual conversations of the second agent.

9. The method according to claim 8, further comprising determining a second set of creativity scores for the second set of textual conversations of the second agent for the second time-period, based on the determined second set of edge weights.

10. The method according to claim 9, further comprising:
determining a set of similarities between the determined first set of creativity scores for the first agent for the first time-period and the determined second set of creativity scores for the second agent for the second time-period; and
determining the first creativity score for the first agent based on the determined set of similarities.

11. The method according to claim 10, further comprising:
determining a second creativity score for the second agent based on the determined set of similarities; and
generating behavioral information, related to the second agent, based on the determined second creativity score.

12. The method according to claim 10, further comprising applying a dynamic time warping function on the determined first set of creativity scores and the determined second set of creativity scores to determine the set of similarities.

13. The method according to claim 12, wherein a length of the first time-period and a length of the second time-period are different from each other.

14. The method according to claim 1, wherein the plurality of textual messages of the plurality of textual conversations include at least one of chat messages, short messaging service (SMS) messages, or electronic mails (e-mail).

15. One or more non-transitory computer-readable storage media configured to store instructions that, in response to being executed, cause a system to perform operations, the operations comprising:
storing a plurality of textual conversations, wherein each textual conversation of the plurality of textual conversations corresponds to a plurality of textual messages shared between a plurality of agents and a plurality of customers;
retrieving a first set of textual conversations of a first time-period from the stored plurality of textual conversations, wherein the first set of textual conversations correspond to a first agent of the plurality of agents;
determining a first set of features of each textual message in the retrieved first set of textual conversations of the first time-period;
determining a first creativity score for the first agent based on the determined first set of features of the first set of textual conversations; and
generating behavioral information, related to the first agent, based on the determined first creativity score.

16. The one or more computer-readable storage media according to claim 15, wherein the determining the first set of features for each textual message is based on determination of a first plurality of weights associated with one or more words in each textual message in the retrieved first set of textual conversations.

17. The one or more computer-readable storage media according to claim 15, wherein the determined first set of features correspond to a vector representation for each textual message in the retrieved first set of textual conversations.

18. The one or more computer-readable storage media according to claim 15, wherein the plurality of textual messages of the plurality of textual conversations include at least one of chat messages, short messaging service (SMS) messages, or electronic mails (e-mail).

19. An electronic device, comprising:
a memory configured to store a plurality of textual conversations, wherein each textual conversation of the plurality of textual conversations corresponds to a plurality of textual messages shared between a plurality of agents and a plurality of customers; and
a processor, coupled to the memory, wherein the processor is configured to:
retrieve a first set of textual conversations of a first time-period from the stored plurality of textual conversations, wherein the first set of textual conversations correspond to a first agent of the plurality of agents;
determine a first set of features of each textual message in the retrieved first set of textual conversations of the first time-period;
determine a first creativity score for the first agent based on the determined first set of features of the first set of textual conversations; and
generate behavioral information, related to the first agent, based on the determined first creativity score.

20. The electronic device according to claim 19, wherein the plurality of textual messages of the plurality of textual conversations include at least one of chat messages, short messaging service (SMS) messages, or electronic mails (e-mail).
